(19) United States
(12) Patent Application Publication
(10) Pub. No.: US 2026/0274091 A1
(43) Pub. Date: Sep. 17, 2026

(54) COMBINATION OF FUEL CELL AND ALL SOLID STATE BATTERY STACK FOR A VEHICLE

(71) Applicant: Schaeffler Technologies AG & Co. KG, Herzogenaurach (DE)

(72) Inventors: Simon Schlirf, Erlangen (DE); Paul Lindemann, Howard, OH (US); Michael Yanetta, Wadsworth, OH (US)

(73) Assignee: Schaeffler Technologies AG & Co. KG, Herzogenaurach (DE)

(21) Appl. No.: 19/079,896

(22) Filed: Mar. 14, 2025

(51) Int. Cl. B60L 50/75; H01M 8/04007; H01M 8/04029; H01M 8/04082; H01M 8/0432; H01M 8/0438; H01M 8/0444; H01M 8/04746; H01M 10/613; H01M 10/615; H01M 10/6556; H01M 10/6567

(52) U.S. Cl. CPC B60L 50/75; H01M 8/04029; H01M 8/04067; H01M 8/04201; H01M 8/0432; H01M 8/0438; H01M 8/04447; H01M 8/04768; H01M 10/613; H01M 10/615; H01M 10/6556; H01M 10/6567; B60L 2240/14

(57) ABSTRACT

A combined fuel cell and battery unit. The fuel cell and battery are contained in a common housing having tensioning plates for applying a clamping pressure to the fuel cell and battery. Flow passages for the flow of coolant circulate coolant around the fuel cell and the battery.

### TECHNICAL FIELD

The present disclosure relates generally to electric vehicles, and more specifically to a combination fuel cell and battery stack for a vehicle.

### BACKGROUND

Fuel cell hybrid vehicles generally combine a fuel cell with a battery and an electric motor for propulsion. The fuel cell converts chemical energy to electrical energy while the battery stores the electrical energy generated by the fuel cell or captured by regenerative braking. A power management system is used to control the supply of electrical energy to the motor from one or both of the fuel cell and the battery as needed. Typically, the fuel cell and the battery are separate components within the vehicle that are electrically connected.

### SUMMARY

Embodiments according to this disclosure provide a combined fuel cell and battery for an electric vehicle that is lighter and more compact than a separate fuel cell and battery typically used in conventional fuel cell hybrid vehicles.

In accordance with one aspect, a combination fuel cell for a vehicle comprises a housing, a fuel cell, and a battery. The fuel cell and the battery are supported in the housing.

First and second tensioning plates for clamping the fuel cell and the battery together can be provided. The tensioning plates can be on opposite sides of the housing, and at least one tensioning member can extend between the tensioning plates. The housing can include inlet and outlet ports for the supply and return of cooling fluid for cooling at least one of the fuel cell or the battery. The housing can include inlet and outlet ports for the supply and return of hydrogen to the fuel cell. The housing can include inlet and outlet ports for the supply and return of air to the fuel cell. A separation plate between the fuel cell and the battery can be provided. The separation plate can include a flow passage. A valve can be configured to control a flow of coolant through the flow passage. The valve can include at least one of a gate valve or a bending metal valve. A sensor suite for sensing at least one operational characteristic of the combination fuel cell can be provided. The sensor suite can include at least one of a temperature sensor, a hydrogen sensor, a vibration sensor, or an accelerometer.

In accordance with another aspect, a combination fuel cell for a vehicle comprises a fuel cell and a battery supported in a common housing, first and second tensioning plates on opposite sides of the housing for clamping the fuel cell and the battery together, and at least one tensioning member extending between the tensioning plates.

A separation plate between the fuel cell and the battery can be provided. The separation plate can include a flow passage for a flow of cooling fluid between the fuel cell and the battery within the housing. A valve can control the flow of coolant through the flow passage. The combination fuel cell can further include a sensor suite for sensing at least one operational characteristic of the combination fuel cell, and the valve can be configured to open or close based at least in part on the at least one sensed operational characteristic. The valve can be configured to direct waste heat from the fuel cell to the battery. The sensor suite can include at least one of a temperature sensor, a hydrogen sensor, a vibration sensor, or an accelerometer. The valve can include at least one of a gate valve or a bending metal valve.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a schematic illustration of a combined fuel cell and battery unit in accordance with the present disclosure;

FIG. 2 is a schematic view of a valve in an open position in accordance with the present disclosure.

FIG. 3 is a schematic view of a valve in a closed position in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

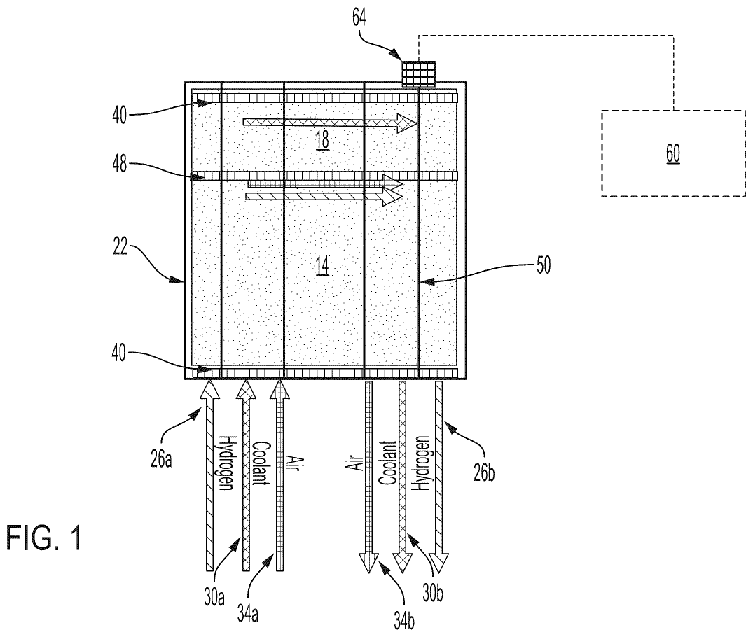

Referring to FIG. 1, an exemplary combined fuel cell and battery unit in accordance with the present disclosure is schematically illustrated and identified generally by reference numeral 10. The combined fuel cell and battery unit 10 generally comprises a fuel cell 14 and a battery 18. The fuel cell 14 can be a hydrogen fuel cell and the battery can be an all solid state battery, for example. The combined fuel cell and battery unit 10 includes a housing 22 in which the fuel cell 14 and the battery 18 are contained. Supply and return ports are provided for hydrogen 26a/26b, coolant 30a/30b, and air 34a/34b.

First and second tensioning plates 40 and 44 are provided at opposite sides of the housing 22 for applying a clamping force to the fuel cell 14 and the battery 18. A separation/insulating plate 48 separates the fuel cell 14 from the battery 18. Clamping force can be applied to the fuel cell 14 and battery stack via the tensioning plates 40 and 44 and/or the housing 22 via one or more tensioning members. In this regard, tie rods 50 can be provided extending between the tensioning plates 40 and 44.

Combining the fuel cell 14 and the battery 18 in a common housing 22 not only results in a more compact and lightweight design, but allows a thermal management system 60 of the fuel cell 14 and the battery 18 to be combined thereby increasing efficiencies. Hydrogen and air is circulated to the fuel cell 14 via respective supply and return ports 26a/26b and 34a/34b while coolant is circulated to the fuel cell 14 and the battery 18 via supply and return ports 30a/30b. A sensor suite 64 monitors the amount of hydrogen and/or other parameters and provides feedback to the thermal management system 60. The sensor suite 64 can also detect thermal runaway of the battery 18. The sensor suite 64 can measure the pressure, hydrogen concentration and temperature, which are indicators, that a thermal runaway took place. Additionally, the sensor suite 64 can include a shock sensor to sense accidents and crashes. The temperature of the coolant can also be measured by the sensor suite 64.

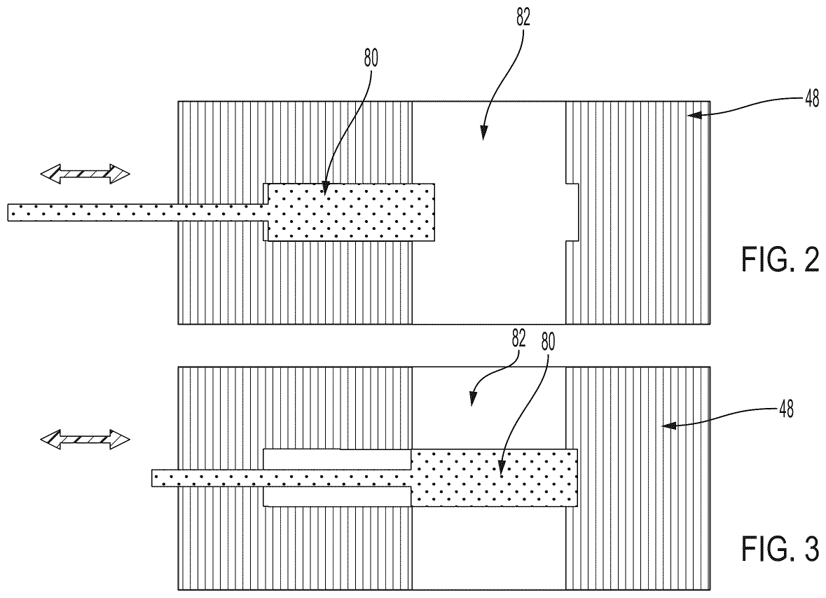

In some embodiments, heat generated by the fuel cell 14 can be circulated to the battery 18 for warming the battery 18. In this regard, cooling flow passages within the housing 22 can include one or more valves for circulating/recirculating coolant warmed by the fuel cell 14 to the battery 18. In FIGS. 2 and 3, an exemplary gate valve 80 is illustrated in an open position FIG. 2) and a closed position (FIG. 3). The gate valve 80 can be used for controlling the flow of coolant through a cooling passage 82 in the separation plate 48. It will be appreciated that other flow control devices can be used to control flow as desired including various valves, orifices, etc. that work to control and distribute cooling fluid throughout the system as needed. In one embodiment a bending metal valve can be used. The bending metal valve can have two materials of different coefficients of thermal expansion that cause the bending metal valve to automatically open and close under certain thermal conditions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 fuel cell and battery unit
14 fuel cell
18 battery
22 housing
26a hydrogen supply port
26b hydrogen return port
30a coolant supply port
30b coolant return port
34a air supply port
34b air return port
40 tensioning plate
44 tensioning plate
48 separation/insulating plate
50 tie rods
60 thermal management system
64 sensor suite
80 valve
82 cooling passage

What is claimed is:

1. A combination fuel cell for a vehicle comprising:
a housing;
a fuel cell; and
a battery;
wherein the fuel cell and the battery are supported in the housing.

2. The combination fuel cell according to claim 1, further comprising first and second tensioning plates for clamping the fuel cell and the battery together.

3. The combination fuel cell according to claim 2, wherein the tensioning plates are on opposite sides of the housing, and wherein at least one tensioning member extends between the tensioning plates.

4. The combination fuel cell according to claim 3, wherein the housing includes inlet and outlet ports for the supply and return of cooling fluid for cooling or warming at least one of the fuel cell or the battery.

5. The combination fuel cell according to claim 4, wherein the housing includes inlet and outlet ports for the supply and return of hydrogen to the fuel cell.

6. The combination fuel cell according to claim 5, wherein the housing includes inlet and outlet ports for the supply and return of air to the fuel cell.

7. The combination fuel cell according to claim 1, further comprising a separation plate between the fuel cell and the battery.

8. The combination fuel cell according to claim 7, wherein the separation plate includes a flow passage.

9. The combination fuel cell according to claim 8, wherein a valve is configured to control a flow of coolant through the flow passage.

10. The combination fuel cell according to claim 9, wherein the valve includes at least one of a gate valve or a bending metal valve.

11. The combination fuel cell according to claim 1, further comprising a sensor suite for sensing at least one operational characteristic of the combination fuel cell.

12. The combination fuel cell according to claim 1, wherein the sensor suite includes at least one of a temperature sensor, a hydrogen sensor, a vibration sensor, or an accelerometer.

13. A combination fuel cell for a vehicle comprising:
a fuel cell and a battery supported in a common housing;
first and second tensioning plates on opposite sides of the housing for clamping the fuel cell and the battery together; and
at least one tensioning member extending between the tensioning plates.

14. The combination fuel cell according to claim 13, further comprising a separation plate between the fuel cell and the battery.

15. The combination fuel cell according to claim 14, wherein the separation plate includes a flow passage for a flow of cooling fluid between the fuel cell and the battery within the housing.

16. The combination fuel cell according to claim 15, wherein a valve controls the flow of coolant through the flow passage.

17. The combination fuel cell according to claim 15, further comprising a sensor suite for sensing at least one operational characteristic of the combination fuel cell, wherein the valve is configured to open or close based at least in part on the at least one sensed operational characteristic.

18. The combination fuel cell according to claim 17, wherein the valve is configured to direct waste heat from the fuel cell to the battery.

19. The combination fuel cell according to claim 17, wherein the sensor suite includes at least one of a temperature sensor, a hydrogen sensor, a vibration sensor, or an accelerometer.

20. The combination fuel cell according to claim 17, wherein the valve includes at least one of a gate valve or a bending metal valve.
